(19) United States
(12) Patent Application Publication
(10) Pub. No.: US 2017/0139779 A1
(43) Pub. Date: May 18, 2017

(54) CONTROLLER, STORAGE SYSTEM, AND NON-TRANSITORY COMPUTER-READABLE STORAGE MEDIUM HAVING CONTROL PROGRAM STORED THEREIN

(71) Applicant: FUJITSU LIMITED, Kawasaki-shi (JP)

(72) Inventor: Yuichiro Yamaguchi, Kahoku (JP)

(73) Assignee: FUJITSU LIMITED, Kawasaki-shi (JP)

(21) Appl. No.: 15/347,867

(22) Filed: Nov. 10, 2016

(30) Foreign Application Priority Data
Nov. 18, 2015 (JP) 2015-225605

(51) Int. Cl. G06F 11/14; G06F 3/06

(52) U.S. Cl. CPC G06F 11/1448; G06F 3/065; G06F 3/0619; G06F 3/067; G06F 3/0665; G06F 2201/80; G06F 2201/84

(57) ABSTRACT

A controller for a second storing device is disclosed. The controller is adapted to restore a first logical volume provided in a first storing device, into a second logical volume. The controller comprises a memory and a processor. The processor that executes a process comprises: obtaining specific information for identifying the first logical volume being a volume to be restored, based on restore processing data comprising data of the first logical volume and first setting information about the first storing device, with reference to a shared directory structure in the first storing device; extracting, from the first setting information, second setting information associated with the first logical volume, based on the obtained specific information; and generating third setting information about the second storing device, based on the extracted second setting information. As a result, data in a logical volume can be easily restore.

### CROSS-REFERENCE TO RELATED APPLICATION

This application is based upon and claims the benefit of priority of the prior Japanese Patent application No. 2015-225605, filed on Nov. 18, 2015, the entire contents of which are incorporated herein by reference.

### FIELD

The embodiment discussed herein is directed to a controller, a storage system, and a non-transitory computer-readable storage medium having a control program stored therein.

### BACKGROUND

In a storage apparatus including network attached storage (NAS) volumes, a NAS setting file and NAS data are maintained.

The NAS setting file is a text file in which various NAS settings are described.

FIG. 8 is a diagram depicting an example of a NAS setting file on the setting for a shared directory.

In FIG. 8, a shared directory setting file is illustrated as an example of a NAS setting file.

A single shared directory setting file is provided for the entire apparatus, and an entry of a single line is written for one shared directory.

The example depicted in FIG. 8 indicates settings for shared directories, including shared directory “share 1” and “share 2” created in NAS Volume 3, and shared directories “share 3” and “share 4” created in NAS Volume 4.

Note that a NAS setting file is stored in a NAS management volume, and is duplicated to and stored in a NAS volume during evacuation processing.

NAS data is user data in the NAS volume. In the NAS, an administer user creates a shared directory, and permits file operations from the outside via the samba or Network File System (NFS) services. General users create files and directories under the shared directory using such services.

A NAS volume number is also set to a NAS volume. The NAS volume number is a unique identifier for identifying each NAS volume.

FIG. 9 is a diagram depicting an example of a data structure in a NAS volume.

The NAS standard stipulates that the directory “data” be created immediately under the root, and that shared directories be located immediately under the directory “data”.

In the example depicted in FIG. 9, two Shared directories, “share1” and “share2”, are created under the directory “data”. The shared directories are shared using samba or the NFS for storing user data, and are generally created by users.

In evacuation processing of data in such a NAS volume, initially, a NAS setting file in which various settings for NAS functions are defined, is stored in a NAS volume. Thereafter, the entire data in the NAS volume, i.e., NAS data, and NAS setting files are copied to a backup volume.

FIG. 10 is a diagram depicting an example of a NAS volume during evacuation processing, where NAS data and a NAS setting file are stored.

In the example depicted in FIG. 10, a shared directory setting file and a Quota setting file are stored under the directory “setting”.

Upon restoring data evacuated in a backup volume as described above, initially, the entire data in the backup volume, i.e., NAS data, and the NAS setting file are copied to the NAS volume. Thereafter, the NAS settings are restored with reference to the setting file in the NAS volume.

Further, evacuation processing and restore processing of a NAS volume as described above, are executed in an inter-enclosure migration, for example. In an inter-enclosure migration, data is migrated from a first enclosure to a second enclosure via a remote line.

FIG. 11 is a diagram for illustrating an inter-enclosure migration.

In an inter-enclosure migration, initially, evacuation processing is executed in a first storage apparatus (enclosure A) as a migration source. Specifically, after a NAS setting file is stored in a NAS volume (refer to the symbol P01), NAS data and a NAS setting file in the NAS volume are copied to a backup volume (refer to the symbol P02).

The entire data in the backup volume in the enclosure A is then copied to a backup volume in a second storage apparatus (enclosure B) as a migration destination, in an inter-enclosure copy (refer to the symbol P03).

Then, in the enclosure B, restore processing is executed. Specifically, in the enclosure B, initially, the entire data in the backup volume is copied to a NAS volume (refer to the symbol P04). Further, a NAS setting file corresponding to that NAS volume is restored (refer to the symbol P05).

### RELATED-ART DOCUMENTS

### Patent Literatures

Patent Literature 1: Japanese Laid-open Patent Publication No. 2007-94473

Patent Literature 2: Japanese Laid-open Patent Publication No. 2003-330782

Patent Literature 3: Japanese Laid-open Patent Publication No. 09-62499

Upon a restore of the NAS setting file, processing is required to be executed in accordance with to the NAS volume number of the migration source NAS volume. However, depending on modes of the data evacuation, the NAS volume number of the migration source NAS volume may not be identified in the second storing device as the migration destination. To address this issue, a rule is imposed in that the NAS volume number of the migration destination NAS volume is required to match the NAS volume number of the migration source NAS volume. This rule is cumbersome, however, and also may compromise the flexibility of the system design.

### SUMMARY

A controller for a second storing device is provided. The controller is adapted to restore a first logical volume provided in a first storing device, into a second logical volume. The controller includes a memory, and a processor. The processor executes a process including: obtaining specific information for identifying the first logical volume being a volume to be restored, based on restore processing data comprising data of the first logical volume and first setting information about the first storing device, with reference to a shared directory structure in the first storing device; extracting, from the first setting information, second setting information associated with the first logical volume, based on the obtained specific information; and generating third setting information about the second storing device, based on the extracted second setting information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting a hardware configuration of a storage system as one example of an embodiment;

FIG. 2 is a diagram depicting a functional configuration of the storage system as one example of an embodiment;

FIG. 3 is a diagram for illustrating an inter-enclosure migration in the storage system as one example of an embodiment;

FIG. 4 is a diagram for illustrating an inter-enclosure migration processing including evacuation processing in a second evacuation mode and restore processing therefor, in the storage system as one example of an embodiment;

FIG. 5 is a diagram for illustrating how a NAS setting file is restored during restore processing, in the storage system as one example of an embodiment;

FIG. 6 is a flowchart for illustrating processing by a restore processing unit, in the storage system as one example of an embodiment;

FIG. 7 is a diagram for illustrating processing by a first restore processing unit, in the storage system as one example of an embodiment;

FIG. 8 is a diagram depicting an example of a NAS setting file on the setting for a shared directory;

FIG. 9 is a diagram depicting an example of a data structure in a NAS volume;

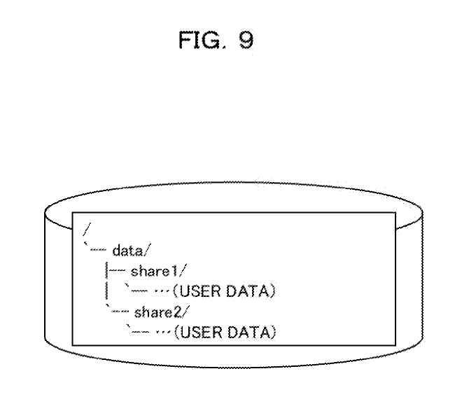

FIG. 10 is a diagram depicting an example of a NAS volume during evacuation processing, where NAS data and a NAS setting file are stored; and

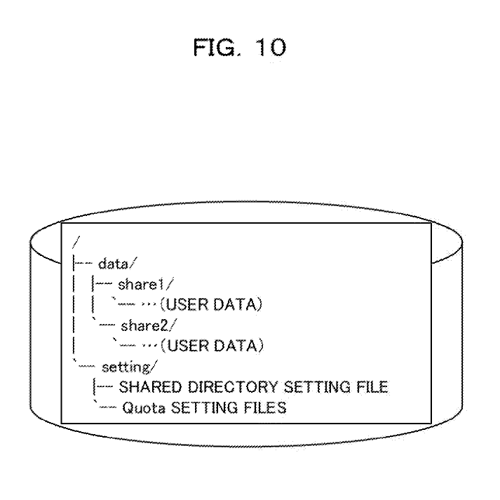

FIG. 11 is a diagram for illustrating an inter-enclosure migration.

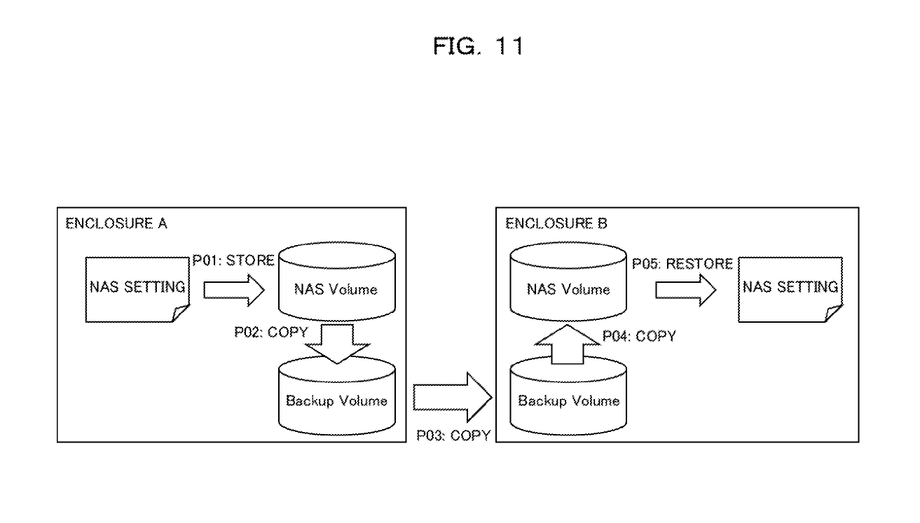

### DESCRIPTION OF EMBODIMENT

Hereinafter, an embodiment according to a controller, a storage system, and a control program will be described with reference to the drawings. However, the embodiment depicted below is by way of example and it is not intended to exclude various modifications and applications of techniques that are not explicitly illustrated in the embodiment. That is, the present embodiment can be practiced by making various modifications without departing from the spirit thereof. Each diagram is not intended to include only structural elements depicted in the drawing and may contain other functions and the like.

(A) Configuration

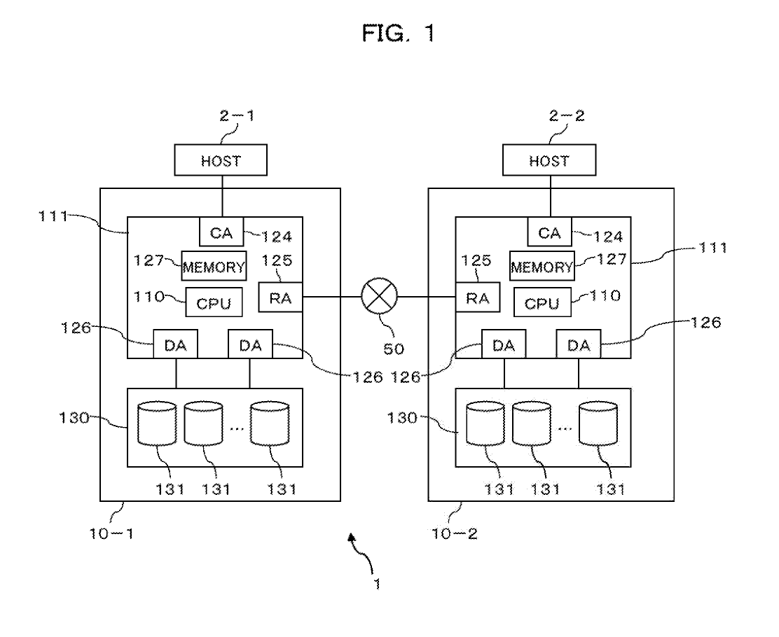

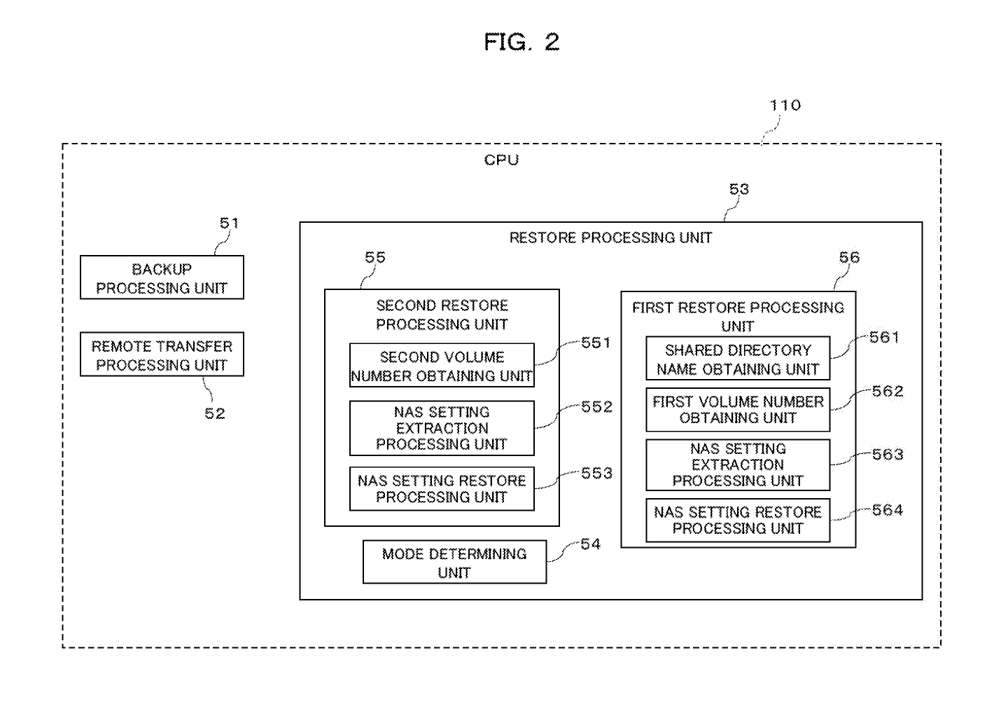

FIG. 1 is a diagram depicting a hardware configuration of a storage system 1 as one example of an embodiment, and FIG. 2 is a diagram depicting a functional configuration thereof.

As depicted in FIG. 1, multiple (two, in the example depicted in FIG. 1) storage apparatuses 10-1 and 10-2 are communicatively connected to the storage system 1 as one example of an embodiment, via a remote line (communication line) 50. The storage apparatuses 10-1 and 10-2 may be provided in locations that are geographically separated.

The storage apparatuses 10-1 and 10-2 have similar configurations. Hereinafter, while a reference symbol 10-1 or 10-2 is used for denoting particular one of the multiple storage apparatuses, a reference symbol 10 is used for denoting any of the storage apparatuses.

Each of the storage apparatuses 10-1 and 10-2 includes one or more (one, in the present embodiment) CMs (information processing apparatuses) 111.

Further, in the example depicted in FIG. 1, a host apparatus 2-1 as an upper-level apparatus is connected to the storage apparatus 10-1, and a host apparatus 2-2 as an upper-level apparatus is connected to the storage apparatus 10-2.

The host apparatuses 2-1 and 2-2 read and write data from and to volumes (logical volumes, virtual volumes) in the storage apparatuses 10-1 and 10-2 connected thereto. For example, the host apparatus 2-1 makes a data access request, such as a read or write, to a volume in the storage apparatus 10-1 as a copy source volume. In response to the data access request, the storage apparatus 10-1 makes a data access to the copy source volume, and responds to the host apparatus 2.

The host apparatuses 2-1 and 2-2 have similar configurations. Hereinafter, while a reference symbol 2-1 or 2-2 is used for denoting particular one of the multiple host apparatuses, a reference symbol 2 is used for denoting any of the host apparatuses.

Note that each host apparatus 2 is an information processing apparatus, and is a computer including a central processing unit (CPU, hard ware processor), a memory, and the like, which are not illustrated, for example.

Each storage apparatuses 10 manages NAS volumes. Each storage apparatuses 10 has a backup function (data evacuation function) for duplicating (evacuating) data and settings (NAS settings) in a NAS volume to a backup destination volume (thereinafter, also referred to as “backup volume”) on a volume basis.

The storage system 1 has an inter-enclosure copy function for copying data between the storage apparatus 10-1 and the storage apparatus 10-2. This inter-enclosure copy function copies entire data in a NAS volume in the storage apparatus 10-1, to a NAS volume in the storage apparatus 10-2, for example.

The inter-enclosure copy function is used for a data migration where a copy of data in a volume in one storage apparatus, is transferred to another storage apparatus.

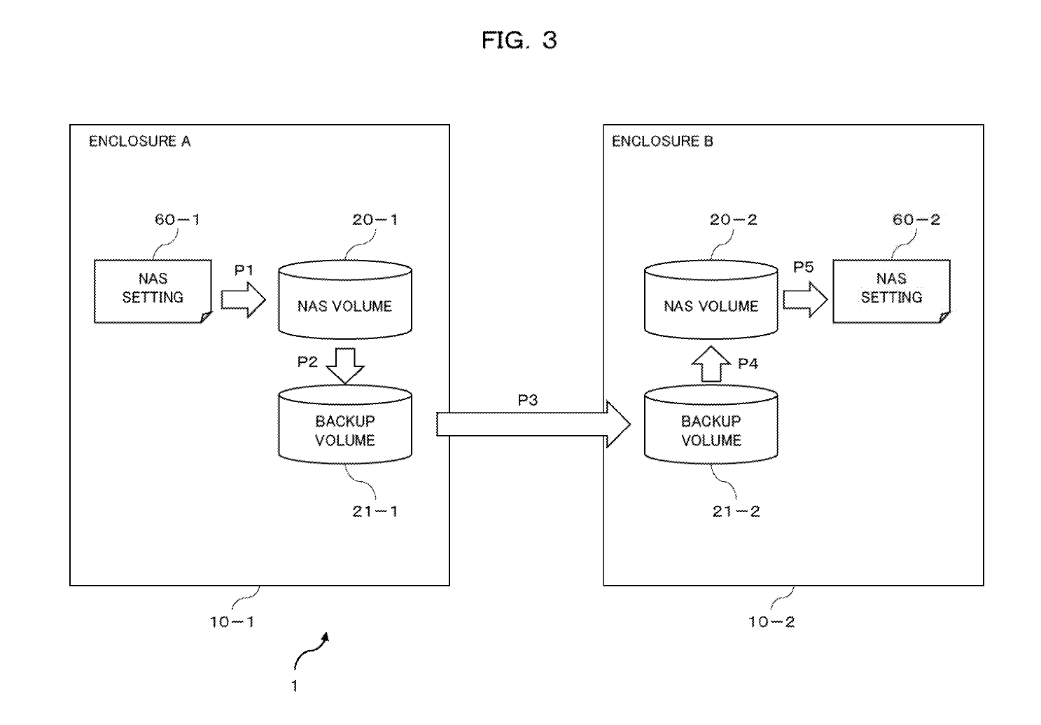

FIG. 3 is a diagram for illustrating an inter-enclosure migration in the storage system 1 as one example of an embodiment.

In the example depicted in FIG. 3, a copy of data in a NAS volume 20-1 provided in the storage apparatus 10-1 is transferred to the storage apparatus 10-2, thereby migrating data between the storage apparatuses 10.

More specifically, in the storage apparatus 10-1, initially, NAS setting information (first setting information) 60-1 is stored in the NAS volume 20-1 that stores data to be migrated (evacuated) (refer to the symbol P1).

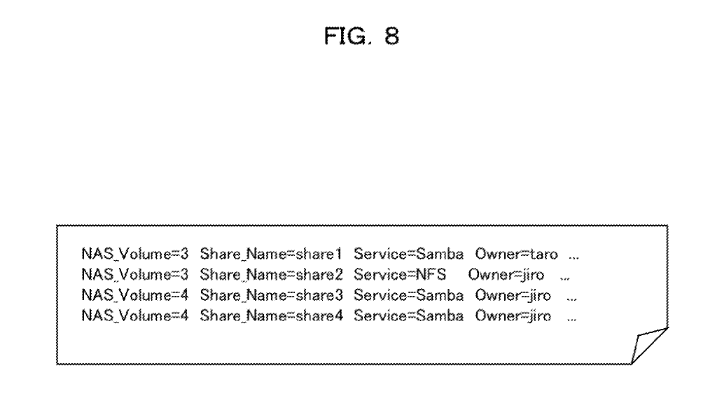

The NAS setting information 60-1 contains various settings (NAS settings) for the NAS as a text file, and includes a shared directory setting file that contains settings for shared directories, for example (refer to FIG. 8).

A single shared directory setting file is provided for the entire storage apparatus 10, and an entry of a single line is written for one shared directory.

The NAS setting information 60-1 is stored in a NAS management volume (not illustrated), which is provided separately from the NAS volume 20-1, and is duplicated to and stored in the NAS volume during evacuation processing.

As described above, the standard of NAS volumes stipulates that the directory “data” be created immediately under the root, and that shared directories be located immediately under the directory “data”.

In a shared directory setting file, such a structure of shared directories is defined as a text file.

The entire data in the NAS volume 20-1 to be backed up and the NAS setting information 60-1 are then duplicated to a backup volume 21-1 (evacuation processing; refer to the symbol P2). Hereinafter, the processing (evacuation processing) for evacuating data in the NAS volume 20-1 to the backup volume 21-1 may also be referred to as “backup processing”.

The entire data in the backup volume 21-1 in the storage apparatus 10-1 is then copied to a backup volume 21-2 in the storage apparatus 10-2 (inter-enclosure copy processing; refer to the symbol P3). Note that the inter-enclosure copy processing may also be referred to as “remote transfer processing”.

Thereafter, in the storage apparatus 10-2, data in the backup volume 21-2 is copied to the NAS volume 20-2 (refer to the symbol P4). In addition, NAS setting information 60-2 is restored (restore processing; refer to the symbol P5).

Hereinafter, the storage apparatus 10-1 as the data migration source may also be referred to as the “enclosure A”, and the storage apparatus 10-2 as the data migration destination may also be referred to as the “enclosure B”.

In addition, hereinafter, the storage apparatus 10-1 may also be referred to as the “migration source apparatus 10-1”, and the storage apparatus 10-2 may also be referred to as the “migration destination apparatus 10-2”. Furthermore, a data transfer between the storage apparatus 10-1 and the storage apparatus 10-2 via the remote line 50 may also be referred to as a “remote transfer”.

In addition, hereinafter, the NAS setting information may also be referred to as the “NAS setting file”.

Note that the above-described inter-enclosure copy function is not solely used for inter-enclosure migrations, but may also be used for a backup and restore across enclosures, between the storage apparatus 10-1 and the storage apparatus 10-2.

The remote line 50 is a communication line for communicatively transmitting data, and enables data transfers based on a standard, such as TCP/IP, for example.

Each storage apparatus 10 is configured to provide the corresponding host apparatus 2 of storage areas, and is a RAID apparatus, for example. While the storage apparatuses 10-1 and 10-2 are connected to the host apparatuses 2-1 and 2-2, respectively, in FIG. 1 for the sake of brevity, two or more host apparatuses may be connected to each of the storage apparatuses 10.

As depicted in FIG. 1, each storage apparatus 10 includes a CM 111 and disk enclosure 130.

Each CM 111 executes various controls for the storage apparatus 10, and executes various controls, such as access controls, to a disk device 131 in the disk enclosure 130, in response to a storage access request (access control signal) from the corresponding host apparatus 2 as an upper-level apparatus. The CM 111 have similar hardware configurations.

Each disk enclosure 130 includes one or more disk devices 131. The disk devices 131 are hard disk drives (HDDs) or solid state drives (SSDs), for example. In the storage apparatuses 10, storage areas in the HDDs 131 are allocated to logical volumes.

As depicted in FIG. 1, each CM 111 includes a channel adapter (CA) 124, a remote adapter (RA) 125, a CPU 110, device adapters (DAs) 126, and a memory 127. While one CM 111 is provided in each storage apparatus 10 in the example depicted in FIG. 1, this is not limiting and two or more CMs 111 may be provided in each storage apparatus 10.

The CA 124 is an interface controller that communicatively connects to the host apparatus 2, and is a Fibra channel adaptor, for example.

For example, when an operator enters an instruction for a data migration from the storage apparatus 10-1 to the storage apparatus 10-2 via the host apparatus 2, the CA 124 receives the data migration instruction.

The RA 125 is an interface controller that communicatively connects (remotely connects) to the other storage apparatus 10 via the remote line 50, and is a Fibra channel adaptor, for example.

The DAs 126 are interface controllers that communicatively connect to the disk enclosure 130, and are Fibra channel adaptors, for example.

The memory 127 is a storing device including a read only memory (ROM) and a random access memory (RAM). A software program for controls for inter-enclosure migrations (the backup control, remote transfer control, and restore control), and data and the like for that program are written in the ROM in the memory 127. The software program on the memory 127 are read into the CPU 110 and is executed by the CPU 110, where appropriate. The RAM in the memory 127 is used as a primary memory or a working memory.

Further, data to be sent to the other storage apparatus 10 is temporarily stored in a particular area in the memory (RAM) 127, for example. In other words, the memory 127 functions as a transfer data buffer that temporarily stores data to be transferred to the other storage apparatus 10, upon a remote transfer, as will be described later.

The ROM in the memory 127 stores programs to be executed by the CPU 110 and various types of data.

The CPU 110 is a processor that executes various controls and computations, and embodies various functions by executing programs stored in the memory 127 or the like.

As depicted in FIG. 2, the CPU 110 in the storage apparatus 10 functions as a backup processing unit 51, a remote transfer processing unit 52, and a restore processing unit 53.

In an inter-enclosure migration processing in the storage system 1, the CPU 110 in the data migration source storage apparatus 10-1 functions as the backup processing unit 51 and the remote transfer processing unit 52, and the CPU 110 in the migration destination storage apparatus 10-2 functions as the restore processing unit 53.

Note that the program for embodying the functions as the backup processing unit 51 and the remote transfer processing unit 52, and the program for embodying the function as the restore processing unit 53 are provided in the form of programs stored in a non-transitory computer-readable storage medium, such as a flexible disk, a CD (e.g., CD-ROM, CD-R, CD-RW), a DVD (e.g., DVD-ROM, DVD-RAM, DVD-R, DVD+R, DVD-RW, DVD+RW, HD DVD), a Blu Ray disc, a magnetic disk, an optical disk, a magneto-optical disk, for example. A computer reads the program from the storage medium with a reader (not illustrated), and transfers it to an internal or external storing device to use the program. Alternatively, the program may be stored in a storing device (storage medium), such as a magnetic disk, an optical disk, a magneto-optical disk, for example, and may be provided to the computer from the storing device through a communication path.

Upon embodying the functions as at least one of the backup processing unit 51, the remote transfer processing unit 52, and the restore processing unit 53, a program stored in a storing device (the memory 127 in the present embodiment) is executed by a microprocessor (the CPU 110 in the present embodiment) in the computer. At this time, the program stored in a storage medium may be read and executed by the computer.

In an inter-enclosure migration, the functions as the backup processing unit 51 and the remote transfer processing unit 52 work in the data migration source (evacuation source) storage apparatus 10 (10-1). The function as the restore processing unit 53 works in the data migration destination storage apparatus 10 (10-2).

The backup processing unit 51 copies data in a NAS volume to be backed up (NAS data) and a setting file for the NAS volume (NAS setting file), to a backup volume in the same storage apparatus 10. In other words, the backup processing unit 51 executes evacuation processing of the NAS volume.

Hereinafter, the technique for evacuating the data in the NAS volume and the NAS setting file, to the backup volume is referred to as “evacuation processing in a first evacuation mode”.

In the first evacuation mode, data in the NAS volume (first logical volume) 20-1 to be subjected to evacuation processing and NAS setting information (first setting information) 60-1 about the storage apparatus (first storing device) 10-1 are stored in the backup volume) 21-1 (evacuation volume) as migration data (restore processing data).

In addition to the evacuation processing in the first evacuation mode as described above, the backup processing unit 51 can also execute evacuation processing in a second evacuation mode.

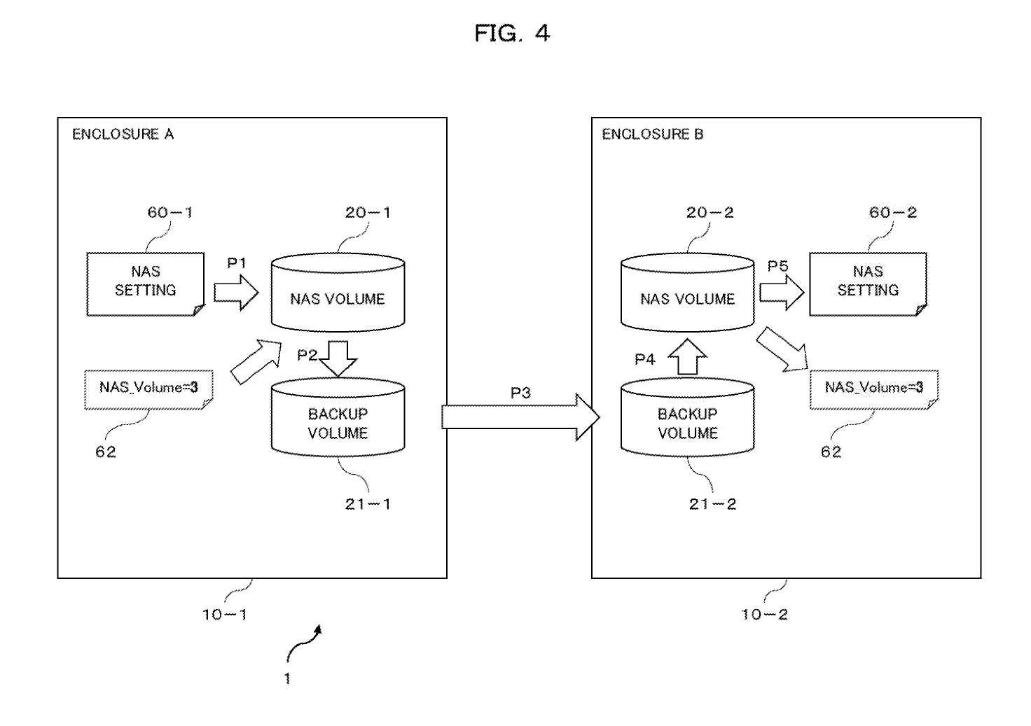

FIG. 4 is a diagram for illustrating an inter-enclosure migration processing including evacuation processing in a second evacuation mode and restore processing therefor, in the storage system 1 as one example of an embodiment.

As depicted in FIG. 4, in the second evacuation mode, the backup processing unit 51 stores NAS volume number information 62 including the volume number (NAS Volume) of the NAS volume 20-1 to be backed up, into the NAS volume 20-1, together with the NAS setting file 60-1, in the migration source storage apparatus 10-1 (enclosure A). The NAS volume number is a number that is uniquely assigned to each NAS volume, and functions as an identifier that identifies that NAS volume.

Hereinafter, the NAS setting file 60-1 to be evacuated may also be referred to as the “evacuation NAS setting file 60-1”.

The backup processing unit 51 then copies (evacuates) the NAS volume number information 62 to the backup volume 21-1 in the same storage apparatus 10, together with data in the NAS volume 20-1 to be backed up (NAS data) and the NAS setting file 60-1.

Accordingly, in the second evacuation mode, in addition to data in the NAS volume to be subjected to evacuation processing (first logical volume 10-1) and the NAS setting information (setting information) 60-1 about the storage apparatus (first storing device) 10-1, the NAS volume number information 62 (identifier) identifying the NAS volume 20-1 is stored into the backup volume (evacuation volume) 21-1, as migration data (restore processing data).

Then, the backup processing unit 51 functions as a first storing processing unit adapted to store migration data (restore processing data) including data in the first logical volume (10-1) and the NAS setting information 60-1 (first setting information) about the first storing device (10-1), into the backup volume (evacuation volume) 21-1.

Note that in the backup processing unit 51, a copy of data from the NAS volume 20-1 to the backup volume 21-1 is achieved by means of the functions of the Storage Area Network (SAN). Thereby, data is transferred from the NAS volume 20-1 to the backup volume 21-1 on a block basis.

As to whether evacuation processing is to be executed in the first evacuation mode or the second evacuation mode, an operator or a system administer can make a corresponding setting.

The remote transfer processing unit 52 executes processing for transferring data in a volume in the storage apparatus 10 to the other storage apparatus 10 via the remote line 50. For example, in the migration source storage apparatus 10-1, the remote transfer processing unit 52 copies the entire data in the backup volume 21-1, to a backup volume 21-2 in the migration destination storage apparatus 10-2.

Note that a data transfer between the storage apparatuses 10 by the remote transfer processing unit 52 may be embodied by means of a wide variety of well-known techniques, and descriptions thereon will be omitted.

The restore processing unit 53 restores a NAS volume using the data stored in the backup volume 21-2, in the migration destination storage apparatus 10-2.

In the migration destination storage apparatus 10-2, the restore processing unit 53 copies the data in the backup volume 21-2 to the NAS volume 20-2. At this time, the restore processing unit 53 also restores (generates) NAS setting information 60-2 for the restored NAS volume 20-2.

As depicted in FIG. 2, the restore processing unit 53 includes a mode determining unit 54, a first restore processing unit 56, and a second restore processing unit 55.

The mode determining unit 54 checks whether the evacuation processing by the backup processing unit 51 on the data that is to be subjected to restore processing, i.e., the data in the NAS volume 20-2, has been executed in the first evacuation mode or the second evacuation mode.

Specifically, in the migration destination storage apparatus 10-2, the mode determining unit 54 determines whether or not NAS volume number information 62 is present in the data to be subjected to restore processing, which has been copied from the backup volume 21-2 to the NAS volume 20-2.

When no NAS volume number information is present in the data to be subjected to restore processing, the mode determining unit 54 determines that the evacuation processing has been executed in the first evacuation mode. Otherwise, when NAS volume number information is present, the mode determining unit 54 determines that the evacuation processing has been executed in the second evacuation mode.

When the mode determining unit 54 determines that the evacuation processing has been executed in the first evacuation mode, restore processing by the first restore processing unit 56, which will be described later, is executed. Otherwise, when the mode determining unit 54 determines that the evacuation processing has been executed in the second evacuation mode, restore processing by the second restore processing unit 55, which will be described later, is executed.

The second restore processing unit 55 is adapted to execute restore processing on data that has been subjected to the evacuation processing in the second evacuation mode.

As depicted in FIG. 4, when the evacuation processing has been executed in the second evacuation mode, NAS volume number information 62 is present in data that has been remotely transferred, in the migration destination storage apparatus 10-2 (enclosure B).

The second restore processing unit 55 restores the NAS setting information 60-2, using the NAS volume number information 62.

As depicted in FIG. 2, the second restore processing unit 55 has functions as a second volume number obtaining unit 551, a NAS setting extraction processing unit 552, and a NAS setting restore processing unit 553.

The second volume number obtaining unit 551 obtains the NAS volume number of the NAS volume 20-1 to be subjected to restore processing, with reference to the NAS volume number information 62.

In other words, the second volume number obtaining unit 551 functions as a second obtaining unit adapted to obtain the NAS volume number information 62 from the migration data.

The NAS setting extraction processing unit 552 extracts a NAS setting corresponding to the obtained NAS volume number from the evacuation NAS setting file 60-2, based on the NAS volume number obtained by the second volume number obtaining unit 551.

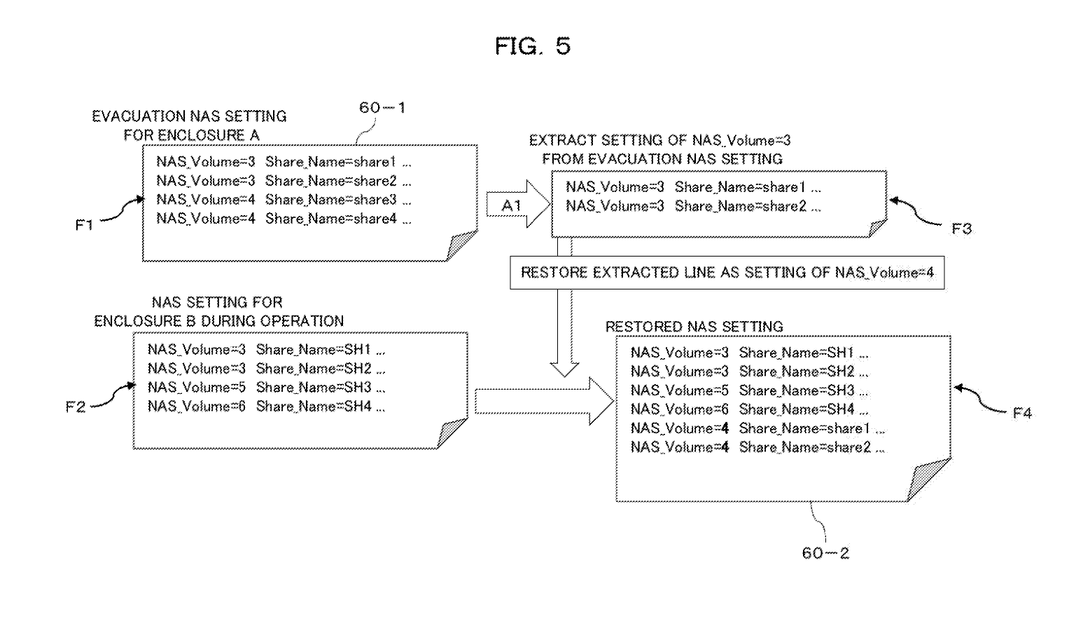

FIG. 5 is a diagram for illustrating how the NAS setting file 60-2 is restored during restore processing, in the storage system 1 as one example of an embodiment.

In the example depicted in FIG. 5, the file indicated by the symbol F1 (File F1) is a NAS setting file (evacuation NAS setting) 60-1 for the NAS volume 20-1 in the data migration source storage apparatus 10-1. The file indicated by the symbol F2 (File F2) is a NAS setting file for the active NAS volume 20-2 in the data migration destination storage apparatus 10-2.

In FIG. 5, the label “NAS_Volume” indicates the NAS volume number, and thus the description “NAS_Volume=3” means that the NAS volume number is 3, for example.

Further, in FIG. 5, the description “NAS_Volume=3 Share_Name=share1” (refer to File F1) means that a shared file having a file name of “share1” is created in the NAS volume having a NAS volume number of 3, for example.

In the example depicted in FIG. 5, in the migration source storage apparatus 10-1, shared files “share1” and “share2” in NAS_Volume=3, and shared files “share3” and “share4” in NAS_Volume=4 have been evacuated in the backup volume 21-1 (refer to File F1).

Further, in the migration destination storage apparatus 10-2, shared files “SH1” and “SH2” in NAS_Volume=3, a shared file “SH3” in NAS_Volume=4, and a shared file “SH4” in NAS_Volume=6 are active (refer to File F2).

In other words, in the data migration source storage apparatus 10-1, two NAS volumes 20-1 with NAS volume numbers of 3 and 4 are defined (refer to the symbol F1). In the data migration source storage apparatus 10-2, three NAS volumes with NAS volume numbers of 3, 5, and 6 are defined (refer to the symbol F2). As described above, the NAS volume number 3 is defined for both the storage apparatus 10-1 and the storage apparatus 10-2.

Further, in the storage apparatus 10-1, the backup processing unit 51 has executed evacuation processing of the NAS volume 20-1 having a NAS volume number of 3 in the second evacuation mode. As a result, the NAS volume number information 62 indicating a NAS volume number of 3 has been stored (evacuated) in the backup volume 21-1, together with the NAS setting information 60-1 and data in the NAS volume.

In the data migration destination storage apparatus 10-2, the second volume number obtaining unit 551 can know that the NAS volume number of the NAS volume to be migrated is 3, with reference to the NAS volume number information 62.

The NAS setting extraction processing unit 552 extracts NAS settings for the NAS volume number 3 (NAS_Volume=3), from the NAS setting information 60-2 that has been copied from the backup volume 21-2 to the NAS volume 20-2.

In the example depicted in FIG. 5, the two lines “NAS_Volume=3 Share_Name=share1 . . . ” and “NAS_Volume=3 Share _Name=share2 . . . ” are extracted as NAS settings for the NAS volume 20-1 having a NAS volume number of 3 (refer to the symbol F3).

In other words, the NAS setting extraction processing unit 552 extracts setting information about the volume to be restored, from the NAS setting information 60-1, based on the NAS volume number obtained by the second volume number obtaining unit 551.

The NAS setting restore processing unit 553 sets a NAS setting file for a NAS volume to be restored in the migration destination storage apparatus 10-2 (such that the NAS volume is restored). Hereinafter, the NAS volume 20-2 to be restored in the migration destination storage apparatus 10-2 may also be referred to as the “migration destination NAS volume 20-2”. The NAS setting restore processing unit 553 generates NAS setting information 60-2 for the migration destination NAS volume 20-2.

The NAS setting restore processing unit 553 generates NAS setting information 60-2 for the migration destination NAS volume 20-2, using the NAS setting extracted by the NAS setting extraction processing unit 552.

In the example depicted in FIG. 5, as described above, the NAS volume number 3 is used for an active NAS volume in the migration destination storage apparatus 10-2. If the storage apparatus 10-2 uses the NAS setting extraction processing unit 552 extracted by NAS setting information for the migration destination NAS volume, the NAS volume number would be allocated to two NAS volumes. Thus, the storage apparatus 10-2 cannot use that NAS volume number.

The NAS setting restore processing unit 553 selects a non-active NAS volume number (4, in this example), and uses it as the NAS volume number of the migration destination NAS volume 20-2.

Specifically, the NAS setting restore processing unit 553 updates NAS setting information for the NAS volume 20-1 having a NAS volume number of 3 in the migration source storage apparatus 10-1, with a NAS volume number of 4, and generates (restores) NAS setting information 60-2 for the migration destination NAS volume 20-2.

Specifically, the NAS setting restore processing unit 553 modifies 3 of the NAS volume number in the NAS settings, which has been extracted by the NAS setting extraction processing unit 552 for the NAS volume number 3 as File F3, to 4. In File F4 exemplified in FIG. 5, the line “NAS_Volume=3 Share_Name=share1 . . . ” in File F1 is modified, to recite “NAS_Volume=4 Share_Name=share1 . . . ”. Similarly, the line “NAS_Volume=3 Share_Name=share2 . . . ” in File F1 is modified, to recite “NAS_Volume=4 Share_Name=share2 . . . ”.

As described above, since the NAS setting restore processing unit 553 generates NAS setting information 60-2 corresponding to the migration destination NAS volume 20-2, the migration destination NAS volume 20-2 becomes available in the migration destination storage apparatus 10-2.

While the NAS volume number of the migration destination NAS volume 20-2 is modified to 4 in the migration destination storage apparatus 10-2 because the NAS volume number 3 used in the migration source storage apparatus 10-1 is used for the active NAS volume in the example depicted in FIG. 5, this is not limiting.

Specifically, when a NAS volume number used in the migration source NAS volume 20-1 is not used in the migration destination storage apparatus 10, the NAS setting restore processing unit 553 may set the NAS volume number of the restore NAS volume, to the migration destination NAS volume.

The first restore processing unit 56 executes restore processing on data that has been subjected to the evacuation processing in the first evacuation mode.

When the evacuation processing has been executed in the first evacuation mode, no NAS volume number information 62 is present in data that has been remotely transferred, in the migration destination storage apparatus 10-2 (enclosure B).

To address this, the first restore processing unit 56 has a function to identify the volume number of the NAS volume 20-1 in which a shared directory is been created, without using NAS volume number information 62.

As depicted in FIG. 2, the first restore processing unit 56 has functions as a shared directory name obtaining unit 561, a first volume number obtaining unit 562, a NAS setting extraction processing unit 563, and a NAS setting restore processing unit 564.

The shared directory name obtaining unit 561 obtains the directory name (shared directory name) of a shared directory in a NAS volume to be subjected to restore processing, i.e., the NAS volume 20-2.

The shared directory name obtaining unit 561 obtains file names and directory names using the is command in Linux®, for example.

For example, for obtaining a shared directory name in the NAS volume number 4, the command “ls/mnt/nas_volume4/data” is executed.

If a shared directory is present in the NAS volume to be subjected to restore processing, the shared directory name obtaining unit 561 obtains the directory name (shared directory name) of the shared directory.

The first volume number obtaining unit 562 obtains the volume number of the NAS volume 20-2 in which the shared directory has been created.

The first volume number obtaining unit 562 obtains the NAS volume number using the awk command in Linux, for example.

Specifically, the first volume number obtaining unit 562 executes the command “awk-v s=obtained name ‘$2==s {print $1} ’ setting file”, for example. Thereby, the second volume number obtaining unit 562 searches the shared directory setting file for the shared directory created in the NAS volume 20-2, for the setting for obtained shared directory name, to obtain the corresponding NAS volume number.

As described above, the shared directory name obtaining unit 561 and the first volume number obtaining unit 562 function as a first obtaining unit adapted to obtain the NAS volume number (first specific information) for identifying the NAS volume (first logical volume) 20-1 to be restored, with reference to the shared directory structure in the storage apparatus 10-1.

The NAS setting extraction processing unit 563 extracts a NAS setting corresponding to the obtained NAS volume number (second setting information) from the evacuation NAS setting file, based on the volume number obtained by the first volume number obtaining unit 562.

In other words, the NAS setting extraction processing unit 563 functions as an extracting unit adapted to extract second setting information associated with the NAS volume 20-1 from the NAS setting information (first setting information) 60-1, based on the NAS volume number obtained by the first volume number obtaining unit 562.

The extraction of the NAS setting by the NAS setting extraction processing unit 563 is achieved with a technique similar to that used by the NAS setting extraction processing unit 552 described above, and descriptions thereon will be omitted.

The NAS setting restore processing unit 564 sets a NAS setting file (third setting information) for the NAS volume to be restored in the migration destination storage apparatus 10-2 (such that the NAS volume is restored).

In other words, the NAS setting restore processing unit 564 functions as a generating unit adapted to generate NAS setting information (third setting information) 60-2 about the storage apparatus 10-2, based on the setting information (second setting information) extracted by the NAS setting extraction processing unit 563.

The NAS setting restore processing unit 564 sets a NAS setting file (third setting information) corresponding to the NAS volume to be restored (the migration destination NAS volume 20-2) in the migration destination storage apparatus 10-2 (such that the NAS volume is restored).

The NAS setting restore processing unit 564 generates NAS setting information 60-2 for the migration destination NAS volume 20-2, using the NAS setting (second setting information) extracted by the NAS setting extraction processing unit 563.

Note that the setting of the NAS setting file by the NAS setting restore processing unit 564 is achieved with a technique similar to that used by the NAS setting restore processing unit 553 described above, and descriptions thereon will be omitted.

As described above, since the NAS setting restore processing unit 564 generates NAS setting information (third setting information) 60-2 corresponding to the migration destination NAS volume 20-2, the migration destination NAS volume 20-2 becomes available in the migration destination storage apparatus 10-2.

(B) Operations

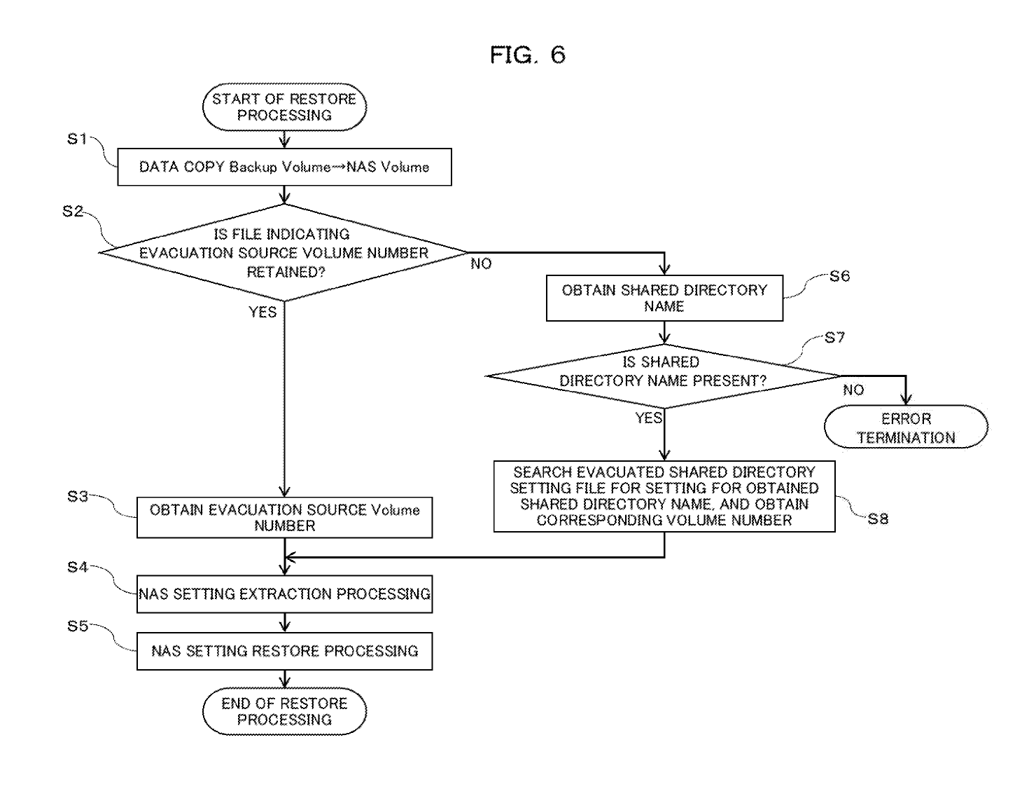

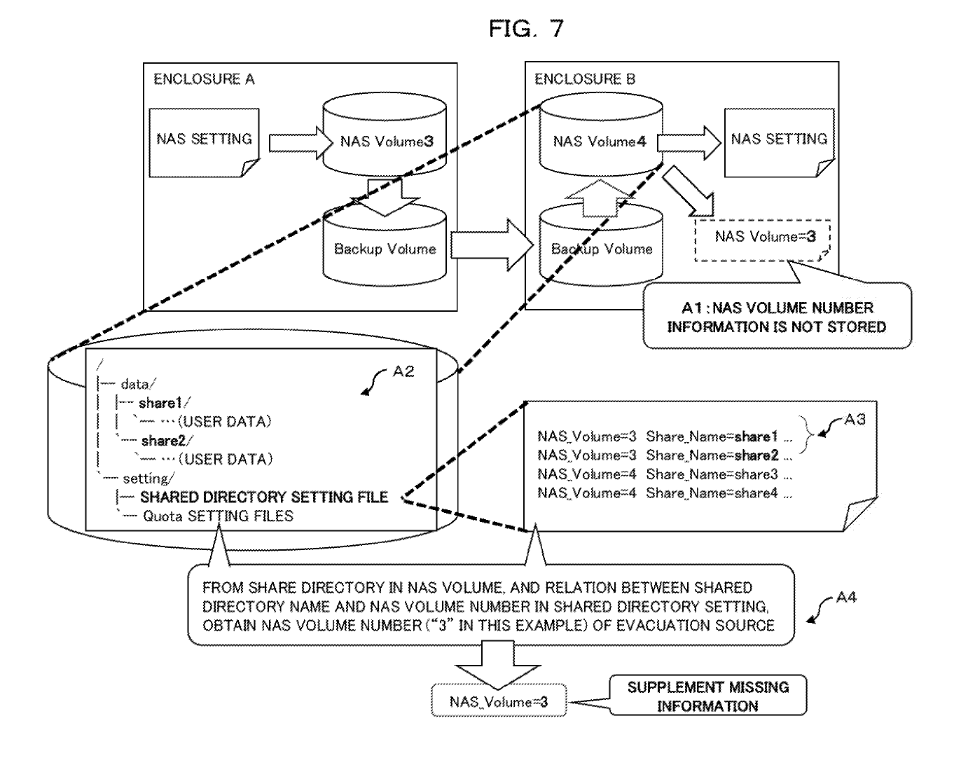

Referring to the flowchart (Steps S1 through S8) depicted in FIG. 6, the processing by the restore processing unit 53 in the storage system 1 configured as described above as one example of an embodiment will be described with reference to FIG. 7. Note that FIG. 7 is a diagram for illustrating processing by the first restore processing unit 56, in the storage system 1 as one example of an embodiment.

An example will be described in which restore processing is executed in the storage apparatus 10-2 after an inter-enclosure migration from the storage apparatus 10-1 to the storage apparatus 10-2 is executed.

Once restore processing (restore processing) is initiated by the restore processing unit 53, initially in Step S1, data in the backup volume 21-2 is copied to the NAS volume 20-2.

In Step S2, the restore processing unit 53 checks whether NAS volume number information 62 for the evacuation source NAS volume is retained in the NAS volume 20-2.

When the NAS volume number information 62 is retained in the NAS volume 20-2 (refer to the YES route from Step S2), the processing transitions to Step S3 and processing by the second restore processing unit 55 is initiated.

Specifically, restore processing of data that has been subjected to the evacuation processing in the first evacuation mode, is executed.

In Step S3, the second volume number obtaining unit 551 obtains NAS volume number information from the data to be subjected to restore processing, and obtains the volume number of the NAS volume to be subjected to restore processing.

In Step S4, the NAS setting extraction processing unit 552 extracts a NAS setting for the obtained NAS volume number from the evacuation NAS setting file, based on the volume number obtained by the second volume number obtaining unit 551.

Thereafter, in Step S5, the NAS setting restore processing unit 553 generates NAS setting information for the migration destination NAS volume, using the NAS setting extracted by the NAS setting extraction processing unit 552, and the processing is terminated.

Otherwise, when the NAS volume number information 62 is not retained in the NAS volume 20-2 (refer to the symbol A1 in FIG. 7) (refer to the NO route from Step S2), the processing transitions to Step S6 and processing by the first restore processing unit 56 is initiated.

Specifically, restore processing on data that has been subjected to the evacuation processing in the second evacuation mode, is executed.

In Step S6, the shared directory name obtaining unit 561 obtains the shared directory name created in a NAS volume to be subjected to restore processing, using the is command or the like (refer to the symbols A2, A3 in FIG. 7).

In Step S7, it is checked whether a shared directory is present. The check reveals that no shared directory is present (refer to the NO route from Step S7), the processing is terminated (error termination). Desirably, an operator or a system administer is notified with an error, which indicates that no shared directory can be obtained.

The check in Step S7 reveals that a shared directory is present (refer to the YES route from Step S7), the processing transitions to Step S8.

In Step S8, the first volume number obtaining unit 562 obtains the volume number of the NAS volume (volume to be subjected to restore processing) in which the shared directory has been created, using the awk command or the like (refer to the symbol A4 in FIG. 7).

In other words, the NAS volume number of the NAS volume 20-1 to be migrated, which is unknown, can be obtained (supplemented) without NAS volume number information 62.

Thereafter, the processing transitions to Step S4 where the NAS setting extraction processing unit 563 extracts NAS setting (second setting information) for the obtained NAS volume number, from the evacuation NAS setting file (first setting information), based on the volume number obtained by the first volume number obtaining unit 562.

In Step S5, the NAS setting restore processing unit 564 generates NAS setting information (third setting information) for the migration destination NAS volume, using the NAS setting extracted by the NAS setting extraction processing unit 563.

(C) Advantageous Effects

As described above, in accordance with the storage system 1 as one example of an embodiment, the backup processing unit 51 executes evacuation processing in the second evacuation mode, in the migration source storage apparatus 10-1. Specifically, the NAS volume number information 62 storing the volume number (NAS Volume) of the NAS volume 20-1 to be backed up, is stored into the NAS volume 20-1, together with the NAS setting file 60-1.

In the migration destination storage apparatus 10-2, the second volume number obtaining unit 551 in the restore processing unit 53 obtains the NAS volume number of the NAS volume 20-1 to be subjected to restore processing, with reference to the NAS volume number information 62.

As a result, the NAS volume number of the NAS volume on which evacuation processing has been executed by the backup processing unit 51 in the migration source storage apparatus 10-1 becomes available in the migration destination storage apparatus 10-2.

The NAS setting extraction processing unit 552 then extracts a NAS setting corresponding to the obtained NAS volume number from the evacuation NAS setting file 60-2, based on the NAS volume number obtained by the second volume number obtaining unit 551. In addition, the NAS setting restore processing unit 553 generates NAS setting information 60-2 for the migration destination NAS volume 20-2, using the NAS setting extracted by the NAS setting extraction processing unit 552.

As a result, in the migration destination storage apparatus 10-2, the NAS setting information for the NAS volume on which evacuation processing has been executed by the backup processing unit 51 in the migration source storage apparatus 10-1 can be restored. As a result, the migrated NAS volume 20-2 also becomes available in the migration destination storage apparatus 10-2, and the shared directory and the like become available. At this time, it becomes possible to restore the NAS volume in the migration destination, without being aware of the NAS volume number in the migration source.

Furthermore, when the backup processing unit 51 has executed evacuation processing in the first evacuation mode in the migration source storage apparatus 10-1, the shared directory name obtaining unit 561 in the restore processing unit 53 obtains the name of a shared directory in the NAS volume to be subjected to restore processing 20-2, in the migration destination storage apparatus 10-2. The first volume number obtaining unit 562 then obtains the volume number of the NAS volume 20-2 in which the shared directory has been created.

As a result, the NAS volume number of the NAS volume on which evacuation processing has been executed by the backup processing unit 51 in the migration source storage apparatus 10-1 becomes available in the migration destination storage apparatus 10-2, without NAS volume number information 62.

The NAS setting extraction processing unit 563 then extracts a NAS setting corresponding to the obtained NAS volume number (second setting information) from the evacuation NAS setting file (first setting information) 60-2, based on the NAS volume number obtained by the first volume number obtaining unit 562. In addition, the NAS setting restore processing unit 564 generates NAS setting information (third setting information) 60-2 for the migration destination NAS volume 20-2, using the NAS setting extracted by the NAS setting extraction processing unit 563.

As a result, the NAS setting information for the NAS volume on which evacuation processing has been executed by the backup processing unit 51 in the migration source storage apparatus 10-1 can be restored in the migration destination storage apparatus 10-2, without using NAS volume number information 62. As a result, the migrated NAS volume 20-2 also becomes available in the migration destination storage apparatus 10-2, and the shared directory and the like become available.

When the backup processing unit 51 has executed evacuation processing in the first evacuation mode in the migration source storage apparatus 10-1, NAS volume number information 62 is not available in the migration destination storage apparatus 10-2. However, when one or more shared directories have been set, it is possible to execute a restore or an inter-enclosure copy.

If no shared directory has been set, an error arises. However, no user data can be retained in a NAS volume unless a shared directory has been set to the NAS volume. Accordingly, it is less likely that no shared directory has been set at the time of the backup.

(D) Miscellaneous

The disclosed technique is not limited to the above embodiment and can be practiced in various modifications without departing from the spirit of the present embodiment.

For example, while the shared directory name obtaining unit 561 obtains file names and directory names using the is command in Linux in the above-described embodiment, this is not limiting.

Specifically, the obtainment of the shared directory name is not limited to the technique with is command, and the shared directory name can be obtained using any other techniques and various modifications can be possible.

In addition, while the first volume number obtaining unit 562 obtains the NAS volume number using the awk command in Linux in the above-described embodiment, this is not limiting.

Specifically, the obtainment of the NAS volume number is not limited to the technique with awk command, and the NAS volume number can be obtained using any other techniques and various modifications can be possible.

Furthermore, while the example has been described where an inter-enclosure migration is executed in the storage system 1 in the above-described embodiment, this is not limiting.

Specifically, for example, data in the NAS volume 20-1 may be evacuated in the backup volume 21-1 for backing it up, and the function as the restore processing unit 53 described above may be used for restoring the data evacuated in the backup volume 21-1. With this configuration, a NAS volume can be easily restored in the migration destination, without being aware of the NAS volume number upon the backup.

While each of the storage apparatuses 10-1 and 10-2 includes a single CM 111 in the above-described embodiment, this is not limiting and two or more CMs 111 may be provided in each of the storage apparatuses 10-1 and 10-2.

Furthermore, various configurations and processing in the present embodiment may be selected or may be combined, where necessary.

The disclosure set forth above enables the present embodiment to be practiced or manufactured by those skilled in the art.

In accordance with one embodiment, data in a logical volume can be easily restored.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the standard relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A controller for a second storing device, the controller being adapted to restore a first logical volume provided in a first storing device, into a second logical volume, the controller comprising:
a memory, and
a processor that executes a process comprises:
obtaining specific information for identifying the first logical volume being a volume to be restored, based on restore processing data comprising data of the first logical volume and first setting information about the first storing device, with reference to a shared directory structure in the first storing device;
extracting, from the first setting information, second setting information associated with the first logical volume, based on the obtained specific information; and
generating third setting information about the second storing device, based on the extracted second setting information.

2. The controller according to claim 1, wherein
the restore processing data comprises an identifier that identifies the first logical volume,
the process further comprises:
obtaining the identifier from the restore processing data; and
extracting, from the first setting information, second setting information associated with the volume to be restored, based on the obtained identifier.

3. The controller according to claim 1, the process further comprises:
determining whether or not the identifier is included in the restore processing data; and
obtaining the specific information when the identifier is not included in the restore processing data.

4. A storage system comprising:
a first storing device adapted to manage a first logical volume;
a second storing device adapted to manage a second logical volume;
a first storing processing unit adapted to store restore processing data comprising data of the first logical volume and first setting information about the first storing device, into an evacuation volume,
a transfer processing unit adapted to transfer the restore processing data stored in the evacuation volume, to the second storing device;
a first obtaining unit adapted to obtain specific information for identifying the first logical volume being a volume to be stored, based on the restore processing data, with reference to a shared directory structure in the first storing device;
an extracting unit adapted to extract, from the first setting information, second setting information associated with the first logical volume, based on the obtained specific information; and
a generating unit adapted to generate third setting information about the second storing device, based on the extracted second setting information.

5. The storage system according to claim 4, further comprising:
a second storing processing unit adapted to store restore processing data comprising data of the first logical volume, first setting information about the first storing device, and an identifier that identifies the first logical volume, into the evacuation volume; and
a second obtaining unit adapted to obtain the identifier from the restore processing data,
wherein the extracting unit is adapted to extract, from the first setting information, second setting information associated with the volume to be restored, based on the identifier obtained by the second obtaining unit.

6. The storage system according to claim 4, further comprising a determining unit adapted to determine whether or not the identifier is included in the restore processing data,
wherein the first obtaining unit is adapted to obtain the specific information when the identifier is not included in the restore processing data.

7. A non-transitory computer-readable storage medium having a control program stored therein, the control program causing a processor to, the processor being in a controller for a second storing device, the controller being adapted to restore a first logical volume provided in a first storing device, into a second logical volume:
obtain specific information for identifying the first logical volume to be restored, based on restore processing data comprising data of the first logical volume and first setting information about the first storing device, with reference to a shared directory structure in the first storing device;
extract, from the first setting information, second setting information associated with the first logical volume, based on the obtained specific information; and
generate third setting information about the second storing device, based on the extracted second setting information.

8. The non-transitory computer-readable storage medium according to claim 7, wherein
the restore processing data comprises an identifier that identifies the first logical volume, and
the control program causes the processor to:
obtain the identifier from the restore processing data; and
extract, from the first setting information, second setting information associated with the volume to be restored, based on the obtained identifier.

9. The non-transitory computer-readable storage medium according to claim 7, wherein the control program causes the processor to:
determine whether or not the identifier is included in the restore processing data; and
obtain the specific information when the identifier is not included in the restore processing data.
